(19) United States
(12) Patent Application Publication
(10) Pub. No.: US 2007/0258336 A1
(43) Pub. Date: Nov. 8, 2007

(54) Methods and apparatuses to characterize time

(76) Inventor: Steven L. Bailey, Port Townsend, WA (US)

Correspondence Address: PELOQUIN, PLLC, 800 FIFTH AVENUE, SUITE 4100, SEATTLE, WA, 98104-3100, US

(21) Appl. No.: 11/473,760

(22) Filed: Jun. 22, 2006

Related U.S. Application Data
(60) Provisional application No. 60/797,005, filed on May 2, 2006.

(51) Int. Cl. G04C 17/00; G04B 19/00; G04B 25/00

(52) U.S. Cl. 368/223

(57) ABSTRACT

Apparatuses and methods that display approximate time are described. An approximate representation of time is displayed on an information display. The approximate representation of time communicates an approximate time to an observer. A characterization indicium associates a theme with the approximate time to provide a characterized approximate time.

### BACKGROUND OF THE INVENTION

1. Field of Invention

Embodiments of the invention relate generally to communicating approximate time and, more specifically, to apparatuses and methods used to visually characterize approximate time.

2. Background

The demands of life in modern society are becoming increasingly complex and burdensome. People routinely process myriads of tasks on a daily basis, in both home and work environments that add to stress that builds up in peoples' lives. Stress has been linked to negative effects on heath, such as for example an increased rate of aging.

The rapid development of technology has also promoted the increased complexity of timepieces. For example, watches and clocks have grown in complexity, often having digital readouts that are capable of reporting time to within a faction of a second. These timepieces often have multiple alarms as well as additional sensors that measure temperature, pressure, direction, etc. and routinely come with an instruction book numbering dozens of pages in length. Such timepieces and their instruction books can add to the burden on life in a modern society, this may present a problem.

Certain aspect of life require a person to take action at certain times of the day or night. For example, a house pet such as an animal can require attention periodically throughout the day. Animals present their owners with a set of chores that must be performed on a routine basis such as feeding, grooming, bathing, sleeping, bathroom visits, etc. Often it a small child that has the responsibility for caring for an animal and the child may not have personally developed the discipline required to properly tend to the animal. For example, dogs often need periodic walks for both exercise and to relive themselves of bodily waste. All animals need periodic feeding. Small children can forget to feed the animal, take the animal for a walk, etc. and in so doing unrest can develop in the home when the child fails in his or her duty toward the animal. This can present a problem. The level of stress in the home can become elevated due to a combination of chores of life, including the failure of children to remember to discharge their duties to the pets that have been placed under their charge. This may present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings in which like references indicate similar elements.

FIG. 1 illustrates elements displayed on an information display, according to various embodiments of the invention.

FIG. 2 illustrates various characterization indicia.

FIG. 3A illustrates a sequence of approximate representations of time, according to one embodiment of the invention.

FIG. 3B illustrates another sequence of approximate representations of time, according to one embodiment of the invention.

FIG. 4A illustrates an information display during a first time interval, according to one embodiment of the invention.

FIG. 4B illustrates an information display during a second time interval, according to one embodiment of the invention.

FIG. 4C illustrates an information display during a third time interval, according to one embodiment of the invention.

FIG. 4D illustrates an information display during a fourth time interval, according to one embodiment of the invention.

FIG. 5A illustrates an information display characterizing noontime according to one embodiment of the invention.

FIG. 5A illustrates an information display characterizing midnight according to one embodiment of the invention.

FIG. 6A depicts using a geometrical expression during a first time interval, according to embodiments of the invention.

FIG. 6B depicts using a geometrical expression during a second time interval, according to embodiments of the invention.

FIG. 6C depicts using a geometrical expression during a third time interval, according to embodiments of the invention.

FIG. 6D depicts using a geometrical expression during a fourth time interval, according to embodiments of the invention.

FIG. 7A illustrates utilizing numerical, text, and graphical expressions to communicate approximate characterized time, according to one embodiment of the invention.

FIG. 7B illustrates communicating an approximate representation of time without numerical or text elements, according to one embodiment of the invention.

FIG. 7C illustrates utilizing graphical expressions to approximate and to characterize time, according to one embodiment of the invention.

FIG. 7D illustrates utilizing a graphical expression to both characterize time and to render time approximate, according to one embodiment of the invention.

FIG. 7E illustrates another example of utilizing a graphical image to both characterize and to render approximate a time period, according to one embodiment of the invention.

FIG. 8 depicts characterizing time using a golf theme, according to one embodiment of the invention.

FIG. 9A illustrates communicating time characterized according to an animal's need for exercise, according to one embodiment of the invention.

FIG. 9B illustrates communicating time characterized according to an animal's need to eat, according to one embodiment of the invention.

FIG. 10A illustrates characterizing time by activities related to the needs of animals, according to embodiments of the invention.

FIG. 10B illustrates characterizing time by activities according to embodiments of the invention.

FIG. 11 illustrates a method of communicating characterizing time according to embodiments of the invention.

FIG. 12 depicts producing approximate characterized time according to embodiments of the invention.

FIG. 13 illustrates a block diagram of a computer system (data processing device) in which embodiments of the invention may be used.

### DETAILED DESCRIPTION

In the following detailed description of embodiments of the invention, reference is made to the accompanying drawings in which like references indicate similar elements and in which are shown by way of illustrations, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense and the scope of the invention is defined only by the appended claims.

Apparatuses and methods are described that produce an approximate characterized time that is communicated to an observer utilizing various embodiments of the invention.

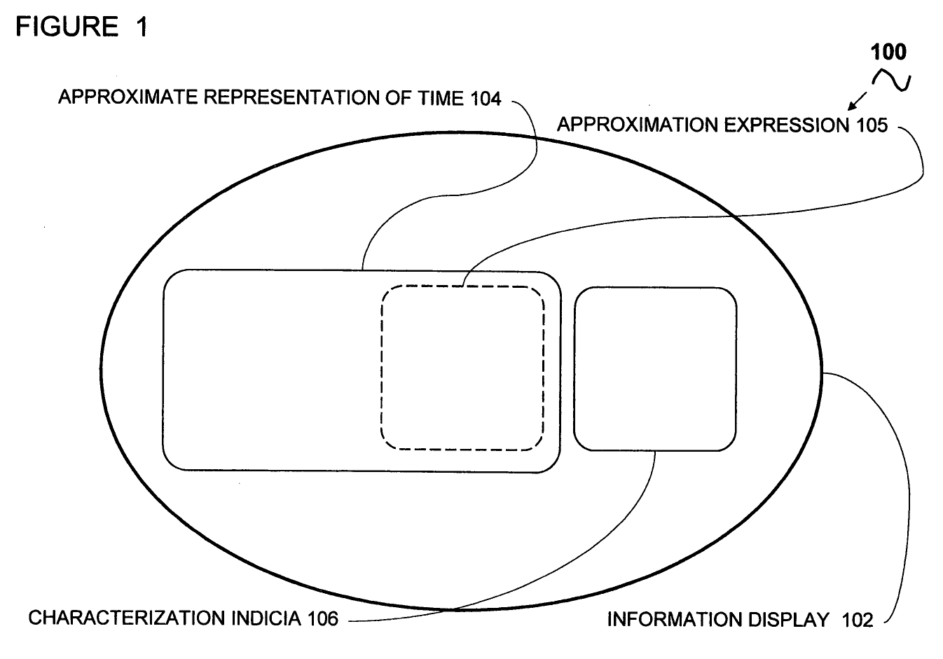

FIG. 1 illustrates elements displayed on an information display, according to various embodiments of the invention, generally at 100. With reference to FIG. 1, an information display 102 contains an approximate representation of time 104. The approximate representation of time 104 can contain an approximation expression 105. A characterization indicium 106 appears on the information display 102, the characterization indicium 106 characterizes an approximate time that is communicated to an observer of the information display 102.

The approximate representation of time 104 can follow a numerical convention to display time, such as by using an hour and minute reference, or an analog convention can be followed utilizing hands, e.g., an hour hand and a minute hand. Within various embodiments of the invention, other conventions can be followed such as using a geometrical expression, e.g., graphical image, geometrical shape, etc. as is described below in conjunction with the figures that follow. Additionally, the approximate representation of time can contain a text message, such as but not limited to, “around,” “ish,” “ish,” “about,” “almost,”“nearly,” after,” etc. as described below.

In various embodiments, an “information display” includes an information display incorporated into a device such as a clock that sits on a table, a clock that is mounted on a wall, etc. In yet other embodiments, an “information display” is a region on a display that is coupled with a data processing device. Examples of data processing devices are but are not limited to, a computer, a smart phone, a personal digital assistant (PDA), etc. It will be noted that a computer can be a personal computer, a workstation, a portable computer, e.g., lap-top computer, tablet computer, etc.

A characterization indicium characterizes approximate time by associating one or more themes with the approximate time. In various embodiments, a characterization indicium associates a place, a message, a thing, etc. with the approximate time displayed on the information display, as will described more fully below.

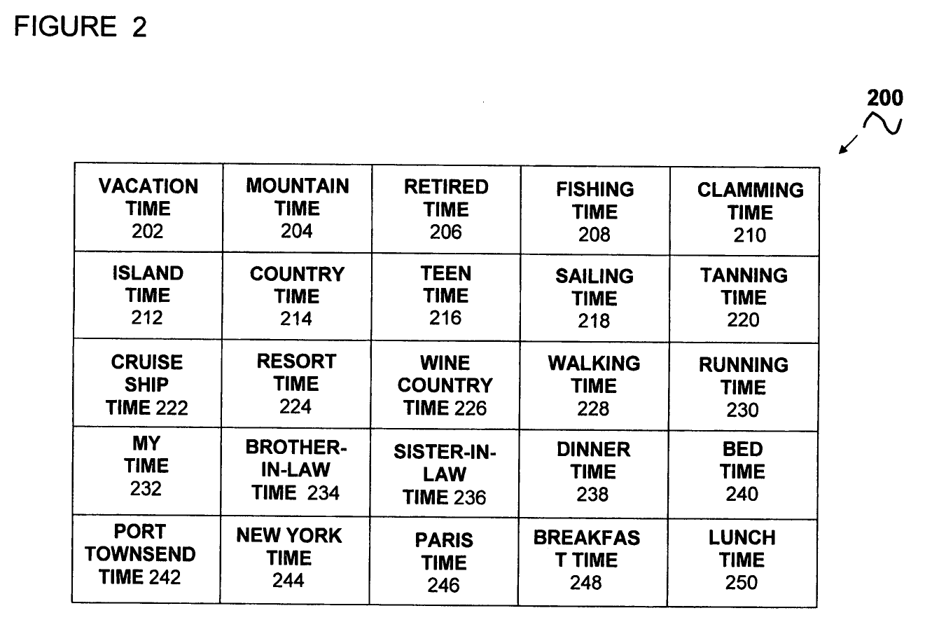

FIG. 2 illustrates various characterization indicia, generally at 200. With reference to FIG. 2, characterization indicia 202 through 250 represent themes that are used to characterize approximate time for display on an information display and presentation to an observer. For example, “ISLAND TIME” 212 characterizes the approximate time displayed on an information display as being associated with an island. In another embodiment, “TEEN TIME” 216 characterizes the approximate time displayed on an information display as being associated with teenage people. An information display can be configured to characterize time differently throughout the day. For example, in one embodiment, “BREAKFAST TIME” is followed by “LUNCH TIME,” which is followed by “RUNNING TIME,” which is followed by “DINNER TIME,” which is followed by “BED TIME,” therein characterizing time by activity. In yet other embodiments, a single characterization indicium characterizes all approximate time communicated by the information display according to a single theme.

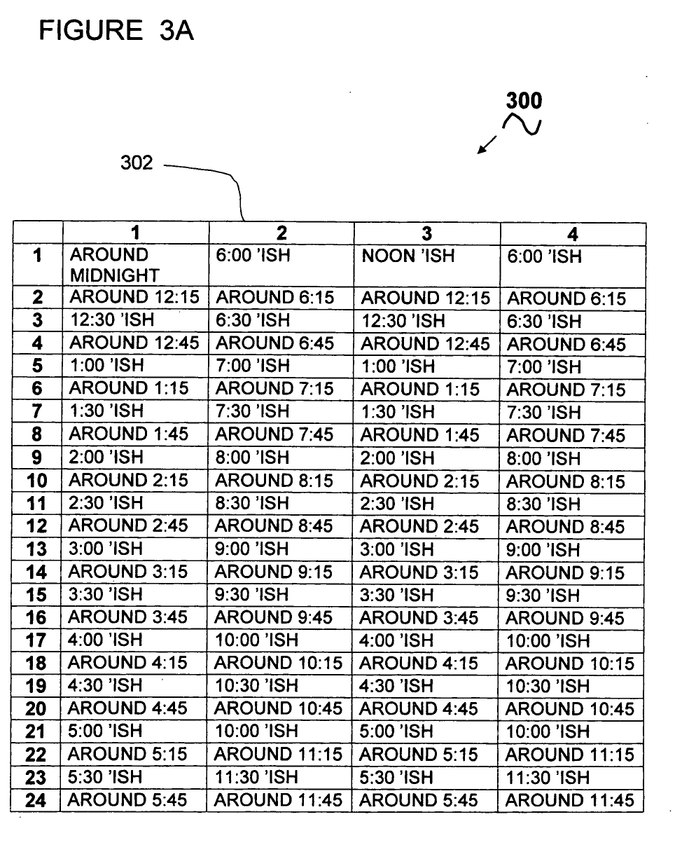

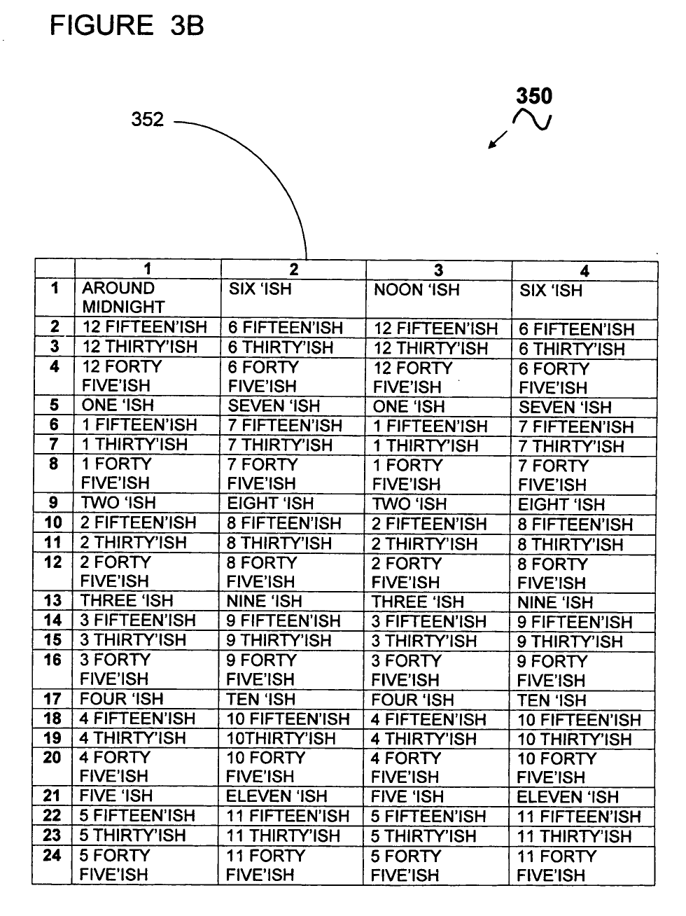

FIG. 3A illustrates a sequence of approximate representations of time, generally at 300, that are displayed sequentially during a twenty-four (24) hour day, according to one embodiment of the invention. With reference to FIG. 3A, a table 302 contains ninety-six (96) different expressions for approximate time within the table's twenty-four (24) rows and four (4) columns. The sequence of approximate representations of time is displayed beginning with column one (1), row (1), i.e., “AROUND MIDNIGHT” proceeding to row two (2), column one (1), i.e., “AROUND 12:15,” etc. until all the values in column one (1) have been displayed. Next, the values in column two (2) are displayed, then the values in column three (3) are displayed, and then the values in column four (4) are displayed. The cycle begins again with column one (1), row one (1).

FIG. 3B illustrates another sequence of approximate representations of time, generally at 350, according to one embodiment of the invention. With reference to FIG. 3B, a table 352 contains ninety-six (96) different expressions for approximate time within the table's twenty-four (24) rows and four (4) columns. The sequence of approximate representations of time can be displayed according to the method described above in conjunction with FIG. 3A.

The sequence shown in table 302 (FIG. 3A) and the sequence shown in table 352 (FIG. 3B) provide four (4) representations of approximate time within a one-hour (1) time period, respectively. These representations of approximate time (table 302) can be displayed at a uniform fifteen-minute (15) interval or they can be displayed at a non-uniform interval, according to various embodiments of the invention. The sequence shown in FIG. 3A and the sequence shown in FIG. 3B are provided for example only and are not meant to limit embodiments of the invention.

Note that other sequences can be assembled using other text messages such as but not limited to; AROUND, ′ISH, ISH, ABOUT, ALMOST, NEARLY, and AFTER. Note also, that other time intervals can be utilized, such as but not limited to, a thirty-minute (30) time interval, a one-hour (1) time interval, etc. Approximate representations of time can also be indicated by a time interval that spans several hours and is not periodic on an hourly basis within a day, examples of which are provided below in conjunction with the figures that follow. In other embodiments, a combination of time intervals are combined within a day.

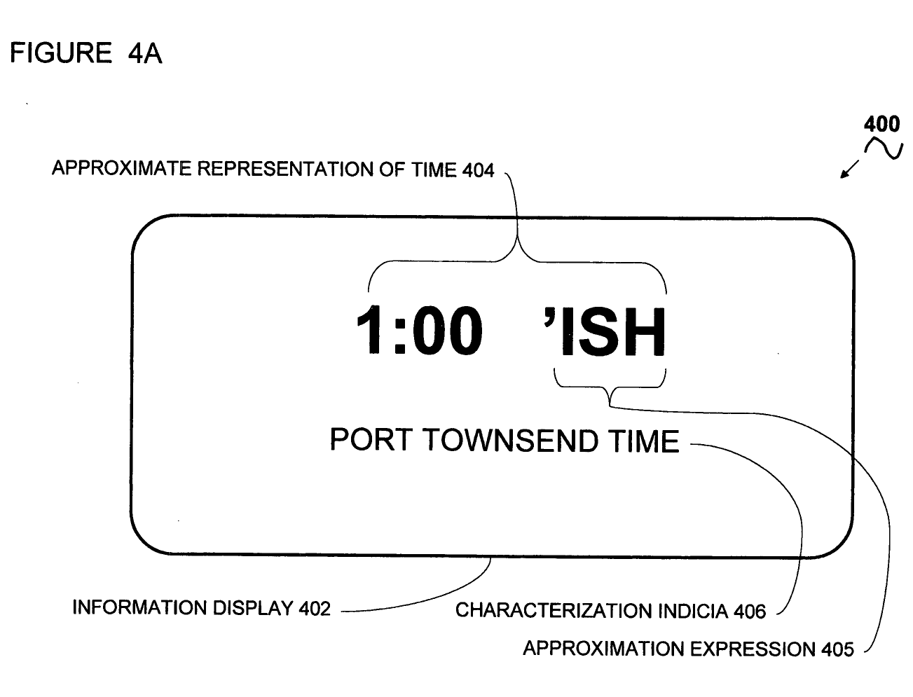

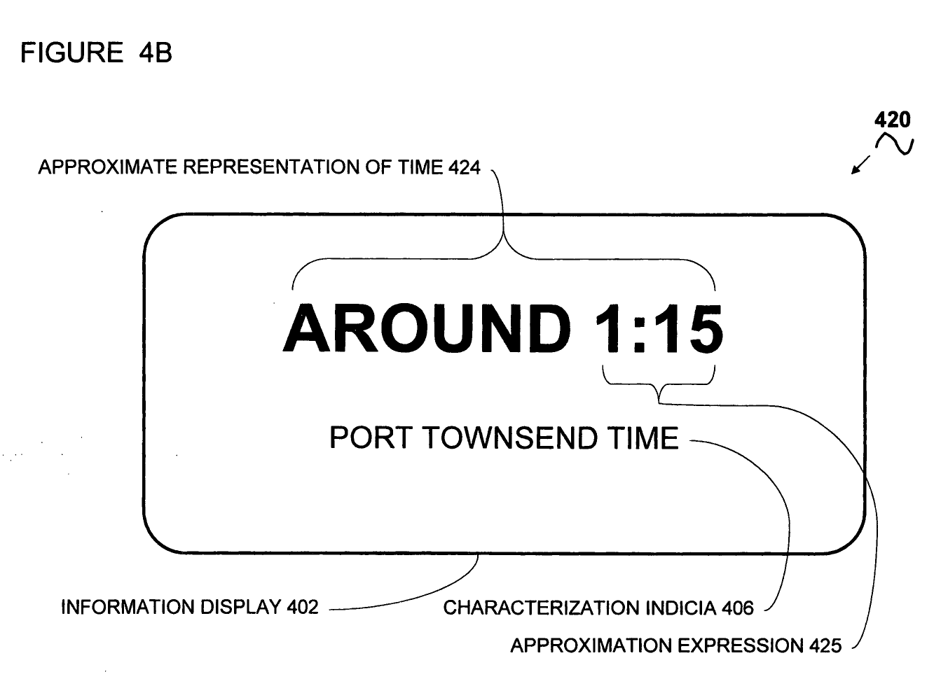

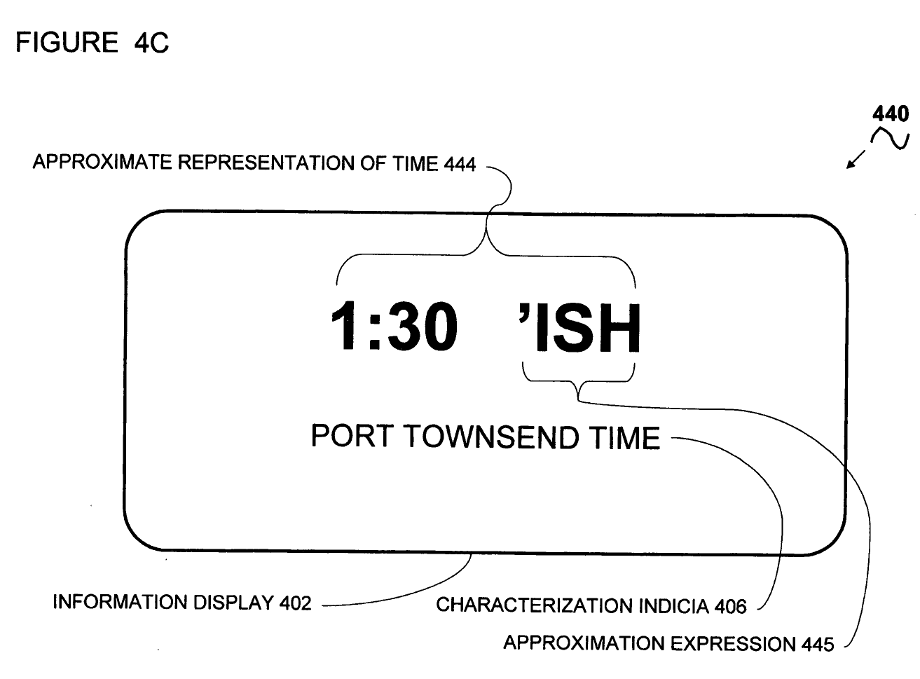

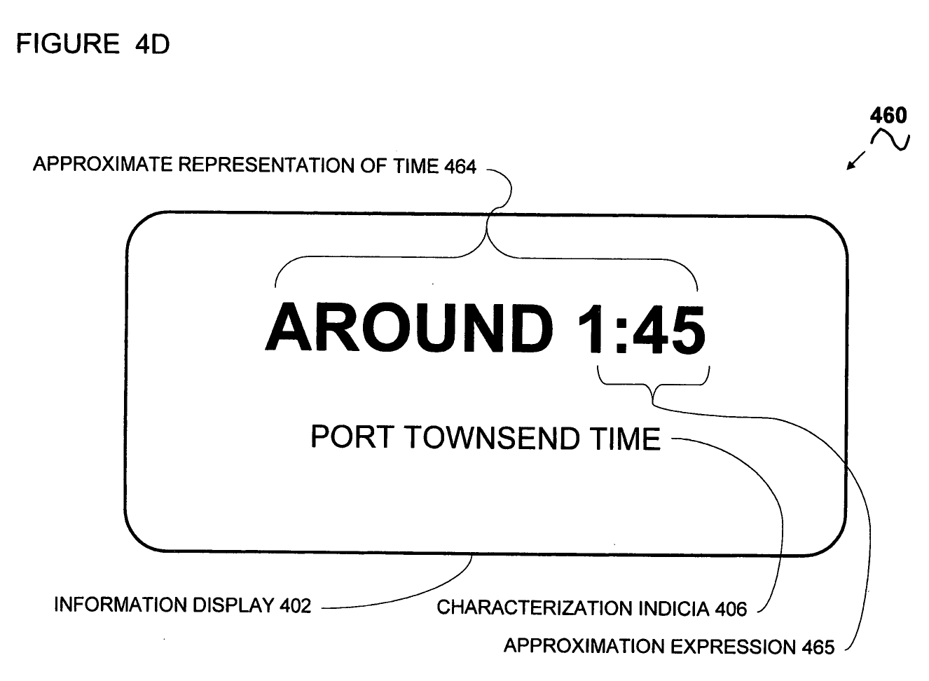

In one embodiment of the invention, FIG. 4A through FIG. 4D depict successive screens of an information display that correspond to a portion of the sequence of approximate representations of time shown in FIG. 3A. For example, FIG. 4A contains an approximate representation of time from FIG. 3A, table 302, entry from column one (1), row five (5), e.g., “1:00 ′ISH.” FIG. 4B contains an approximate representation of time from FIG. 3A, table 302, entry from column one (1), row six (6), e.g., “AROUND 1:15.” FIG. 4C contains an approximate representation of time from FIG. 3A, table 302, entry from column one (1), row seven (7), e.g., “1:30 ′ISH.” FIG. 4D contains an approximate representation of time from FIG. 3A, table 302, entry from column one (1), row eight (8), e.g., “AROUND 1:45.” FIGS. 4A through 4D use a characterization indicium of “PORT TOWNSEND TIME” from FIG. 2 at 242.

Referring back to FIG. 4A, an information display is illustrated, generally at 400, according to one embodiment of the invention. With reference to FIG. 4A, an information display 402, contains an approximate representation of time 404, an approximation expression 405, and a characterization indicium 406. When an observer looks at the information display 400, the time that is discerned by the observer is the approximate representation of time “1:00 ′ISH.” This approximate representation of time is characterized as “PORT TOWNSEND TIME,” implying that in Port Townsend the pace of life is relaxed, time is approximate, and is not noted and/or reported with the precision imparted to the communication of time as is done in other geographical areas. The characterized approximate representation of time is continuously displayed on the information display 402, in one embodiment, for a fifteen (15) minute interval of time starting at approximately seven and one-half (7.5) minutes before one o'clock (1:00) and continuing until seven and one-half (7.5) minutes after one o'clock (1:00). Other display intervals can be employed in various embodiments, and as described above in conjunction with FIG. 3A, non-constant time intervals can be chosen.

The designation a.m. or p.m. is not necessarily included in the approximate representation of time, thereby increasing the lack of precision with which the characterized approximate representation of time is communicated by the information display. Such lack of precision can enhance the degree of characterization attributed to the characterized approximate representation of time. In other embodiments, it can be desirable to include an a.m. designation, a p.m. designation or both designations.

Time marches on; therefore, when an estimate of time, generated by an electronic time measuring device or process running on a suitable data processing device, (e.g. computer, smart phone, personal digital assistant (PDA), etc.) advances and meets a threshold criterion, a new approximate representation of time will be displayed on information display 402. FIG. 4B illustrates such a new approximate representation of time 424 displayed on the information display 402 during a second time interval, according to one embodiment of the invention, generally at 420. The approximate representation of time 424 including approximation expression 425 is displayed on the information display 402, which communicates “AROUND 1:15” to the observer.

Similarly, when time advances and meets a threshold criterion (which can be similar or different from the criterion used for the previous case of FIG. 4B) a new approximate representation of time 444, including approximation expression 445: “1:30 ′ISH” is displayed on the information display 402 as shown in FIG. 4C, generally at 440.

Similarly, when time advances and meets a threshold criterion (which can be similar to or different from the criterion used for the previous cases of FIG. 4A, FIG. 4B, and FIG. 4C) a new approximate representation of time 464 and approximation expression 465: “AROUND 1:45” is displayed on the information display 402 as shown in FIG. 4D, generally at 460. The approximate representations of time (404, 424, 444, and 464) can be displayed on the information display 402 according to a uniform time interval of fifteen (15) minutes since there are four (4) approximate representations of time to be displayed within a one-hour (1) period or the approximate representations of time can be displayed according to any number of non-uniform time intervals. One example of displaying four (4) approximate representations of time according to a non-uniform time interval, within a one-hour (1) period, is ten (10) minutes, twenty (20) minutes, twenty (20) minutes, and ten (10) minutes respectively, for the first through the fourth approximate representations of time. Many other intervals can be selected and embodiments of the invention are not limited by the selection of an interval(s).

Approximate representations of time can include numerical representations of time, such as those presented in the previous figures or an approximate representation of time can be text based without a numerical component. In yet other cases, described below in conjunction with the figures that follow, an approximate representation of time can be expressed graphically without using numerical or text based elements for conveying time. Such graphical expression consists, in various embodiments, of geometrical shapes, designs, patterns, cartoons, images, drawings, etc. It will be understood that in the context of this description of embodiments, the term “graphical expression” is used to encompass geometrical shapes, designs, patterns, cartoons, images, drawings and the like without limitation. In yet other embodiments, a combination of graphical expression and one or more numerical elements or text-based elements are used to communicate an approximate representation of time.

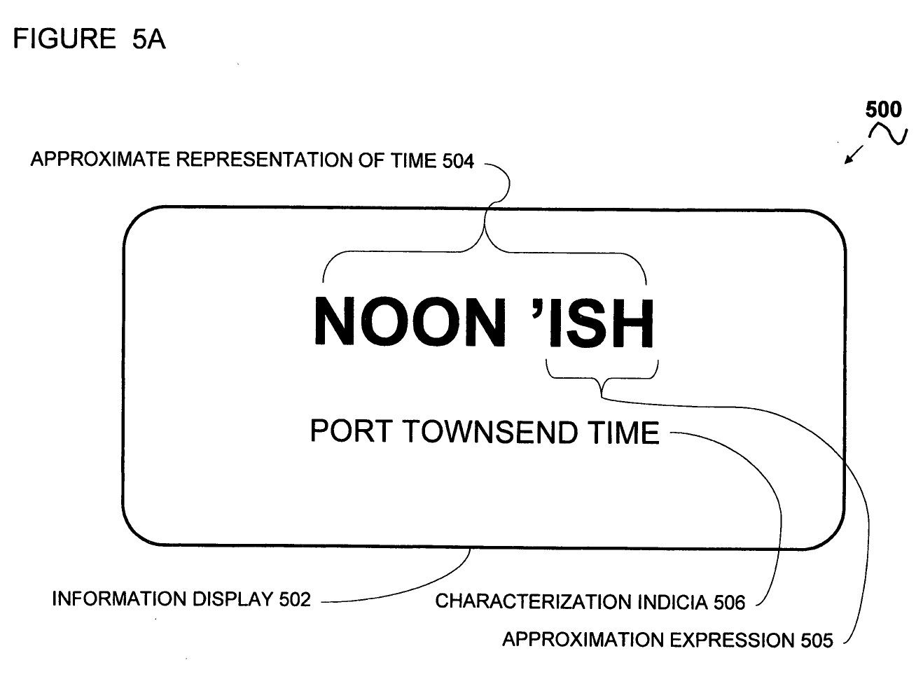

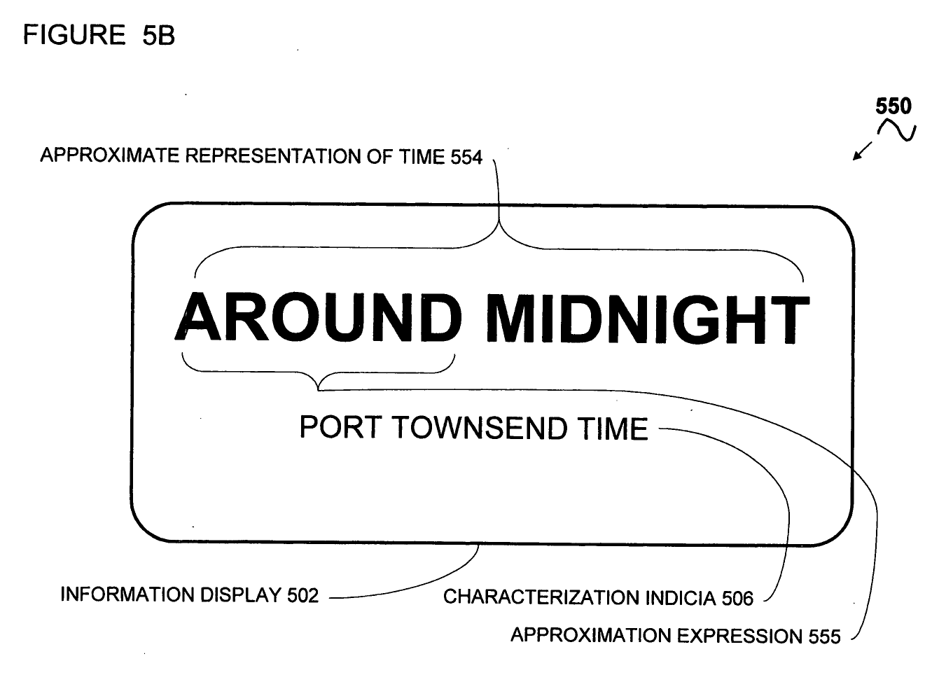

FIG. 5A illustrates an information display, generally at 500, characterizing noontime according to one embodiment of the invention. With reference to FIG. 5A, a text based approximate representation of time 504 is shown as “NOON ′ISH” on an information display 502. An approximation expression 505 “′ISH” is used and a characterization indicium 506 characterizes the approximate representation of time as “PORT TOWNSEND TIME.”

FIG. 5B illustrates an information display, generally at 550, characterizing midnight according to one embodiment of the invention. With reference to FIG. 5B, a text based approximate representation of time 554 is shown as “AROUND MIDNIGHT” on the information display 502. An approximation expression 555 “AROUND” is used and the characterization indicium 506 characterizes the approximate representation of time as “PORT TOWNSEND TIME.”

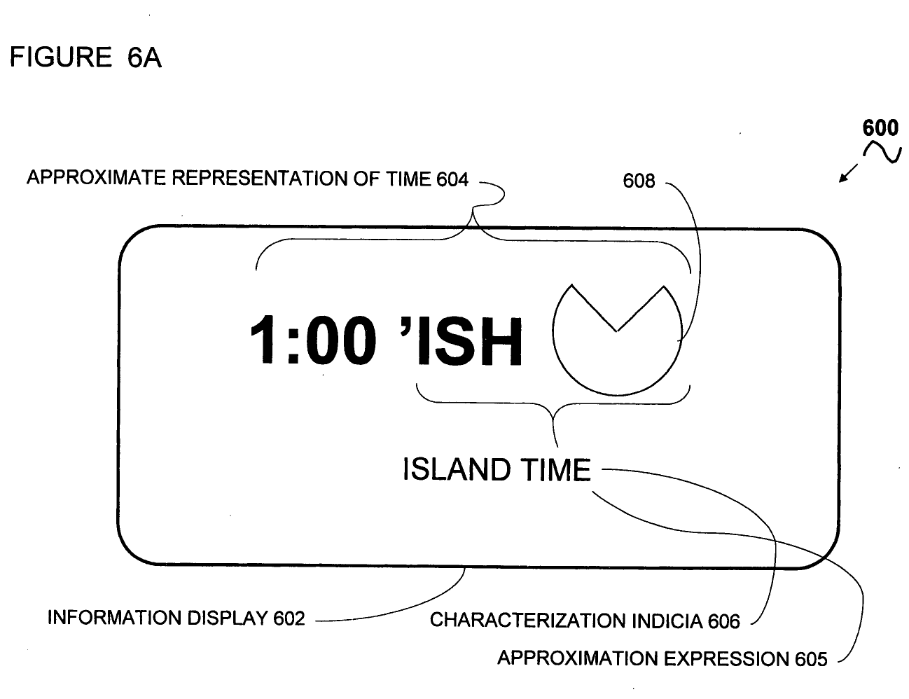

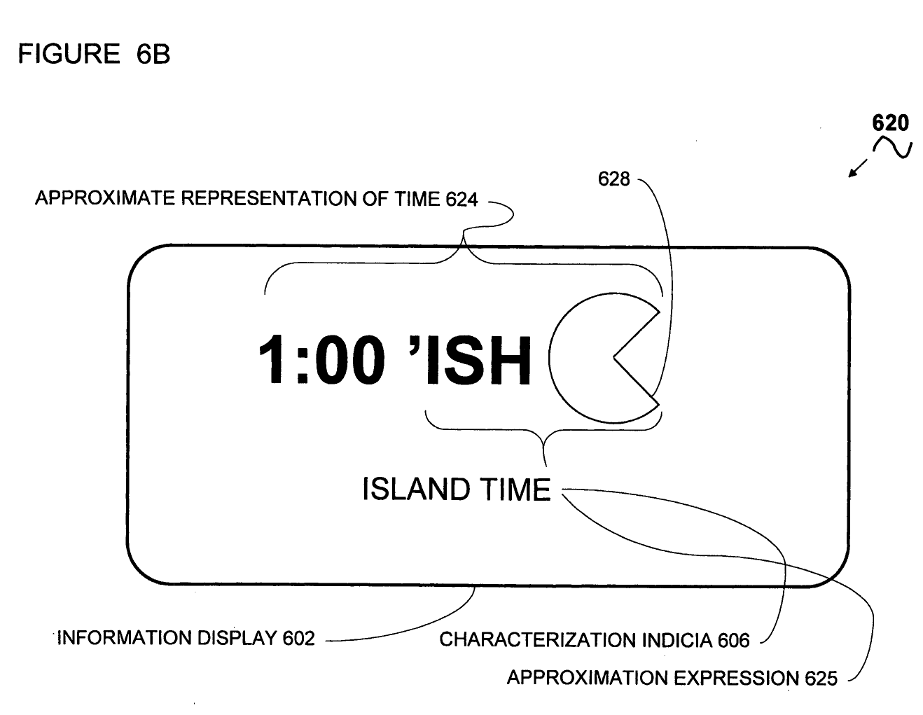

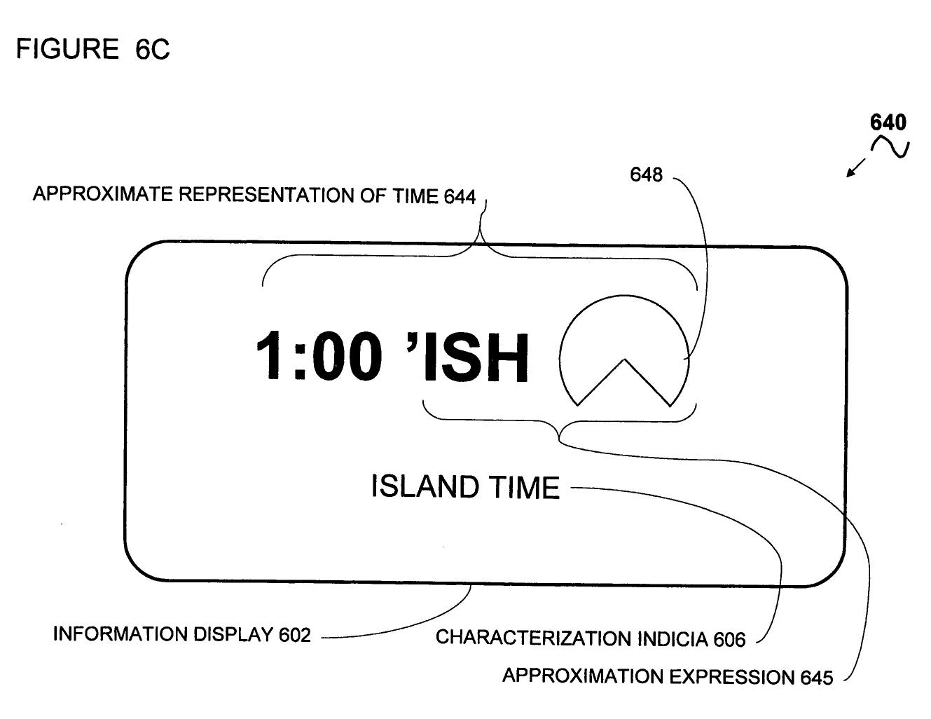

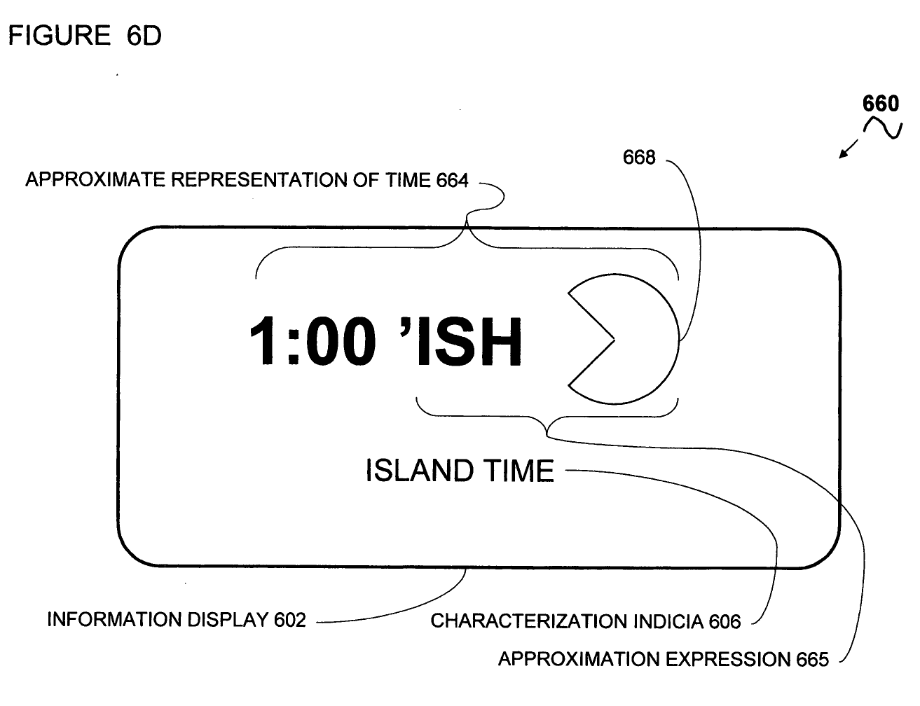

FIG. 6A, FIG. 6B, FIG. 6C, and FIG. 6D illustrate utilizing numerical, text and graphical elements to create an approximate representation of time, suitably characterized as “ISLAND TIME” using a characterization indicium 606, for one embodiment of the invention. FIG. 6A depicts, generally at 600, using a graphical expression during a first time interval, according to embodiments of the invention. With reference to FIG. 6A, an information display 602 contains an approximate representation of time 604. An approximate representation of time 604 includes a numerical element, e.g., “1:00,” a text element, i.e., “′ISH” and a geometrical expression 608. An approximation expression 605 contains the geometrical expression 608, which is rotated as time advances through the time intervals.

In the embodiment shown, the geometrical expression 608 is a circle having a circumferential extent of approximately two hundred and seventy (270) degrees, with a quarter of the circle missing (pie shaped piece). An interpretation convention is employed that uses orientation of the missing quarter circle to indicate a time interval represented by the geometrical expression 608. In one embodiment, the orientation shown in FIG. 6A indicates an interval of time near the hour.

Subsequently, at the next interval in time (second interval), FIG. 6B depicts, generally at 620, using the geometrical expression 608 of FIG. 6A rotated approximately ninety (90) degrees clockwise to the orientation shown at 628 in FIG. 6B. With reference to FIG. 6B, an approximate representation of time 624 contains the same numerical element and text element, e.g., “1:00 ′ISH” from FIG. 6A, what changed between the figures is the orientation of the geometrical expression 608 (FIG. 6A) to the new orientation shown at 628 (FIG. 6B). Applying the interpretation convention mentioned above implies that the orientation shown at 628 indicates time that is approximately a quarter past the hour. Thus, an approximation expression 625 has changed relative to the previous time interval.

Moving ahead to the next interval in time (third interval), FIG. 6C depicts, generally at 640, using the geometrical expression 628 of FIG. 6B rotated approximately ninety (90) degrees clockwise to the orientation shown at 648 in FIG. 6C. With reference to FIG. 6C, an approximate representation of time 644 contains the same numerical element and text element, e.g., “1:00 ′ISH” from FIG. 6B, what changed between the figures is the orientation of the geometrical expression 628 (FIG. 6B) to the new orientation shown at 648 (FIG. 6C). Applying the interpretation convention mentioned above implies that the orientation shown at 648 indicates time that is approximately a half past the hour. Thus, an approximation expression 645 has changed relative to the previous time interval.

Moving further ahead to the next interval in time (fourth interval), FIG. 6D depicts, generally at 660, using the geometrical expression 648 of FIG. 6C rotated approximately ninety (90) degrees clockwise to the orientation shown at 668 in FIG. 6D. With reference to FIG. 6D, an approximate representation of time 664 contains the same numerical elements and text elements, e.g., “1:00 ′ISH” from FIG. 6C, what changed between the figures is the orientation of the geometrical expression 648 (FIG. 6C) to the new orientation shown at 668 (FIG. 6D). Applying the interpretation convention mentioned above implies that the orientation shown at 668 indicates time that is approximately three quarters past the hour. Thus, an approximation expression 665 has changed relative to the previous time interval.

The sequence of characterized approximate representations of time, shown in FIG. 6A through 6D, use “1:00 ′ISH” throughout with the hour designated using one o'clock (1:00), distinctions of time within the hour are communicated by the orientation of the graphical expression with the convention utilizing the missing quarter circle described above. In some embodiments, using a coarser numerical quantization for the communication of the approximate representation of time, as described above in FIGS. 6A through 6D, can convey less precision and exactitude with respect to the communication of characterized time. Decreasing the precision and exactitude associated with the reported time can increase the degree of characterization associated with the displayed approximate representation of characterized time. An example of the foregoing is found in the previous use of, “ISLAND TIME,” where, in this time characterization, the numerical expression “1:00” is retained throughout the four time intervals that are displayed within a period of time spanning one hour.

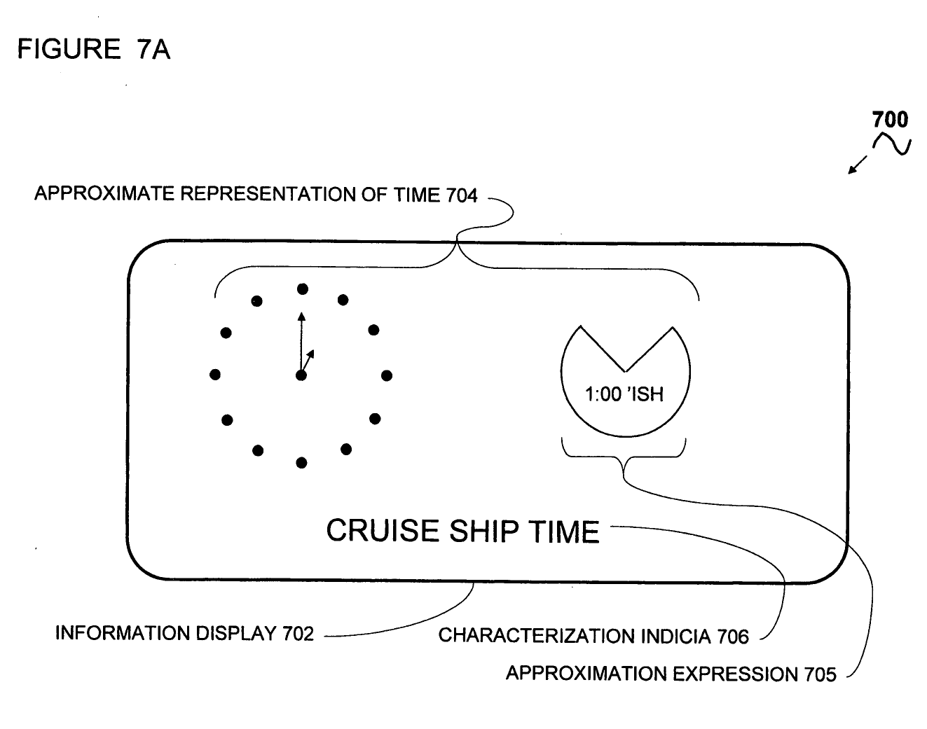

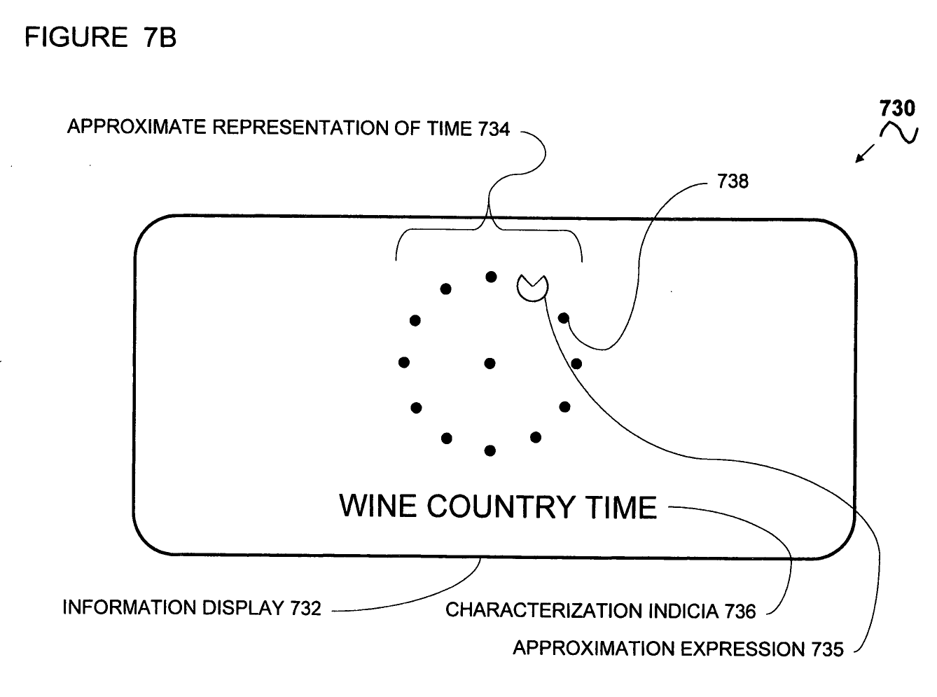

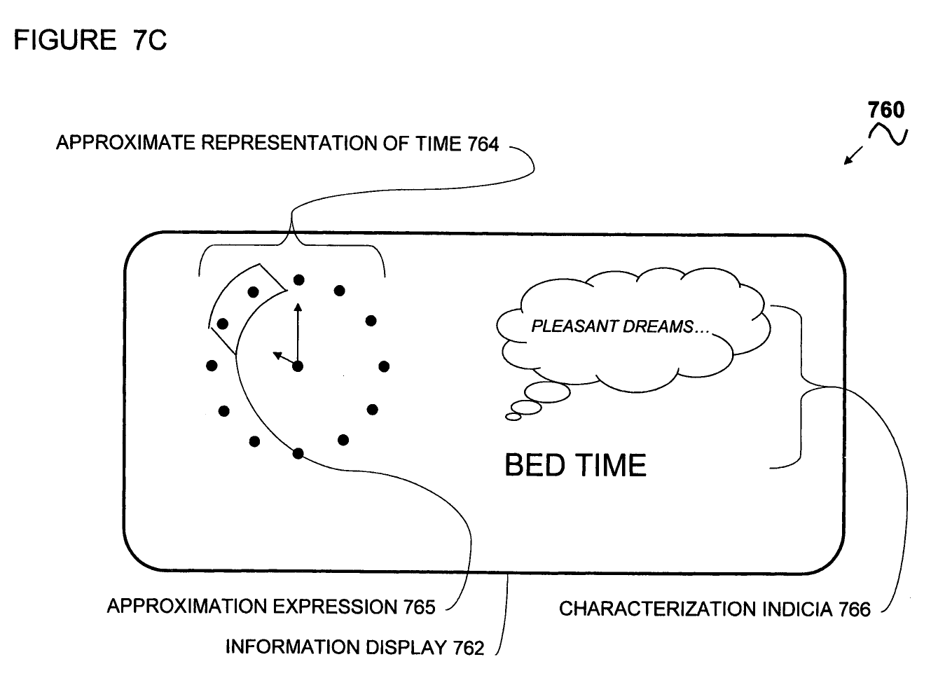

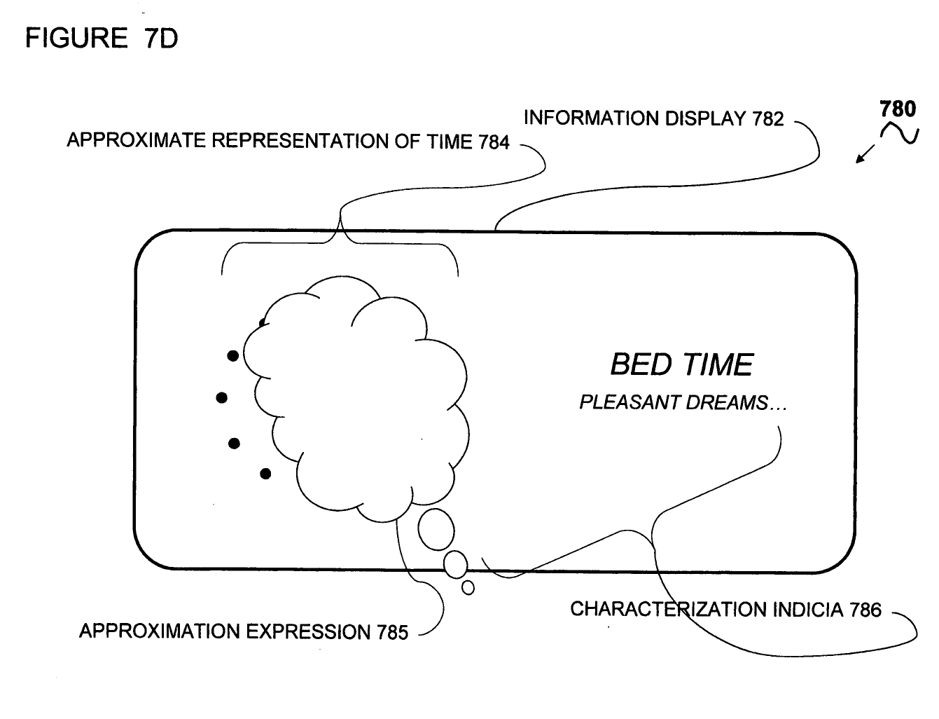

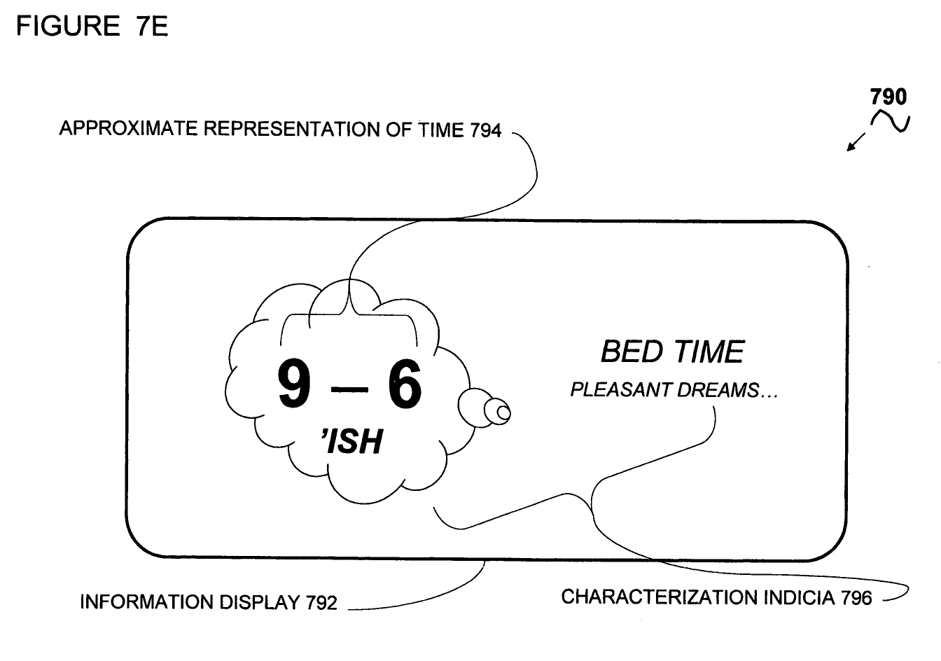

FIG. 7A illustrates utilizing numerical elements, text elements, and graphical expressions to communicate approximate characterized time, generally at 700, according to one embodiment of the invention. With reference to FIG. 7A, an information display 702 includes an approximate representation of time 704. The approximate representation of time 704 includes analog clock hands, graphical images that represent hours, and a graphical image (graphical expression) for approximation expression 705. Approximation expression 705 also includes text and numerical elements, i.e., “1:00,” and “′ISH” respectively. A characterization indicium 706 characterizes the time as “CRUISE SHIP TIME.”

FIG. 7B illustrates communicating an approximate representation of time without numerical or text elements, generally at 730, according to one embodiment of the invention. With reference to FIG. 7B, an information display 732 contains an approximate representation of time 734. The approximate representation of time 734 includes graphical expressions that represent hours and an approximation expression 735 in the form of a graphical expression.

In various embodiments, the approximation expression 735 embodies the functionality previously described in conjunction with the figures above. For example, in one or more embodiments, an orientation of the approximation expression 735 communicates approximate time. In the orientation indicated within FIG. 7B the approximate time is near, around, etc. one o'clock (1:00). Rotation of the approximation expression 735 by ninety (90) degrees in the clockwise direction indicates approximate time that is related to a quarter past one o'clock (1:15). Rotation of the approximation expression 735 by one hundred eighty (180) degrees in the clockwise direction indicates approximate time that is related to a half past one o'clock (1:30). Rotation of the approximation expression 735 by two hundred and seventy (270) degrees in the clockwise direction indicates approximate time that is related to three quarters past one o'clock (1:45).

Within the normal operation of an apparatus embodying the teachings presented within this description of embodiments, time marches on and comes within a time interval of two o'clock (2:00). The approximation expression 735 moves to occupy a position of a graphical expression 738, which represents the hour of two o'clock (2:00). In like manner, as time marches on the approximate representation of time is communicated to an observer as the approximation expression 735 both rotates and moves throughout the graphical expressions that indicate hours within the approximate representation of time 734.

A characterization indicium 736 characterizes the approximate representation of time as “WINE COUNTRY TIME.”

FIG. 7C illustrates utilizing graphical expressions to approximate and to characterize time, generally at 760, according to one embodiment of the invention. With reference to FIG. 7C, an information display 762 has an approximate representation of time 764 displayed thereon. An approximation expression 765, in the form of a quadrilateral geometrical shape, indicates approximate time by enclosing two circles (graphical expressions) that indicate ten o'clock (10:00) and eleven o'clock (11:00). Thus, the approximate time indicated by the approximate representation of time includes ten (10:00) and eleven o'clock (11:00).

Characterization indicium 766 includes text elements and a graphical expression in the shape of a cloud. The cloud shaped graphical expression indicates sleep and, as such, characterizes the approximate representation of time as “BEDTIME.”

FIG. 7D illustrates utilizing a graphical expression to both characterize time and to render time approximate, generally at 780, according to one embodiment of the invention. With reference to FIG. 7D, an information display 782 has an approximate representation of time 784 displayed thereon. A series of twelve graphical expressions (black circles, which are not all visible in 780) signify the hours on a clock face and are displayed on the information display 782. An approximation expression 785, in the shape of a cloud, partially covers a number of the graphical expressions; thereby, indicating a time interval. In this example, the time interval defined by the hours that are either covered or partially covered, includes the hours from eleven (11) o'clock through seven (7) o'clock. The characterization indicium 786 includes both text elements and a graphical expression. In this embodiment, the graphical expression within the characterization indicium 786 and the cloud shaped approximation expression 785 provide a characterization that conveys a theme of sleep/BED TIME. The cloud shaped graphical expression of FIG. 7D is an example of a graphical expression that provides both the functions of approximating time and characterizing time.

FIG. 7E illustrates another example of utilizing a graphical expression to both characterize and to render approximate a time-period, generally at 790, according to one embodiment of the invention. With reference to FIG. 7E, an information display 792 has an approximate representation of time 794 displayed thereon. The approximate representation of time 794 includes numerical elements, i.e., “9” and “6” as well as text based elements, i.e., “′ISH.” A characterization indicium 796 includes a graphical expression in the shape of a cloud and text based elements that characterize the approximate representation of time as having to do with sleep (BEDTIME).

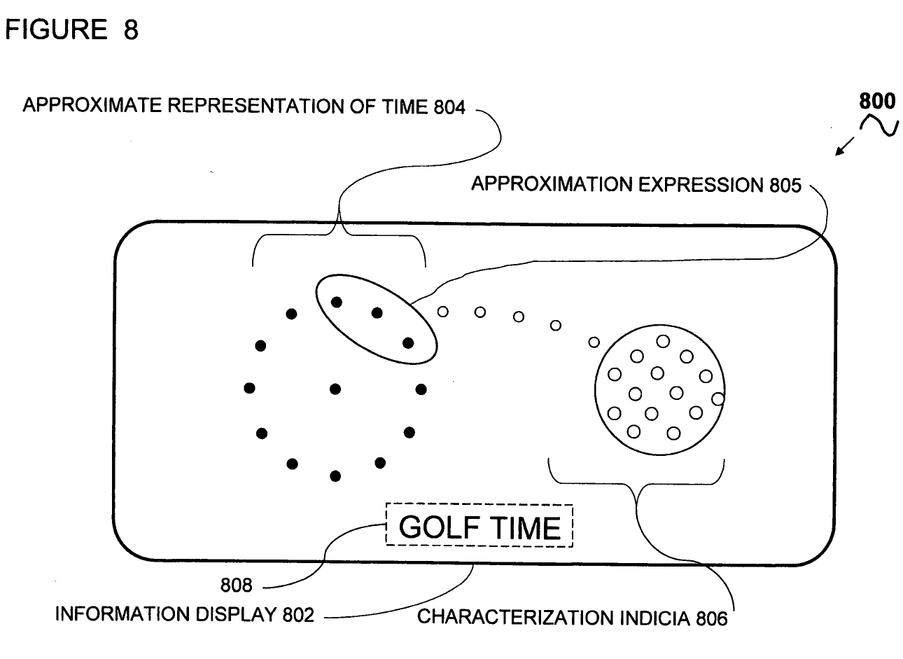

FIG. 8 depicts characterizing time using a golf theme, generally at 800, according to one embodiment of the invention. With reference to FIG. 8, an information display 802 has an approximate representation of time 804 displayed thereon. The approximate representation of time includes graphical expressions in the form of twelve circles that indicate the location of hours on a clock face. An approximation expression 805 is displayed on the information display in the form of an oval which surrounds the circles that represent twelve o'clock (12:00), one o'clock (1:00), and two o'clock (2:00); thereby creating an approximate representation of time in the form of a time interval spanning several hours in length. A characterization indicium 806 in the form of a graphical expression represents a golf ball. The trailing circles in between the approximation expression 805 and the characterization indicium 806 convey a further connection between the time-period and the graphical expression of the golf ball. A text-based element 808, “GOLF TIME,” adds to the characterization of the approximate time as relating to the sport of golf. An observer of the information display 802 receives the communication by virtue of the elements displayed on the information display that the approximate representation of time is characterized as golf time.

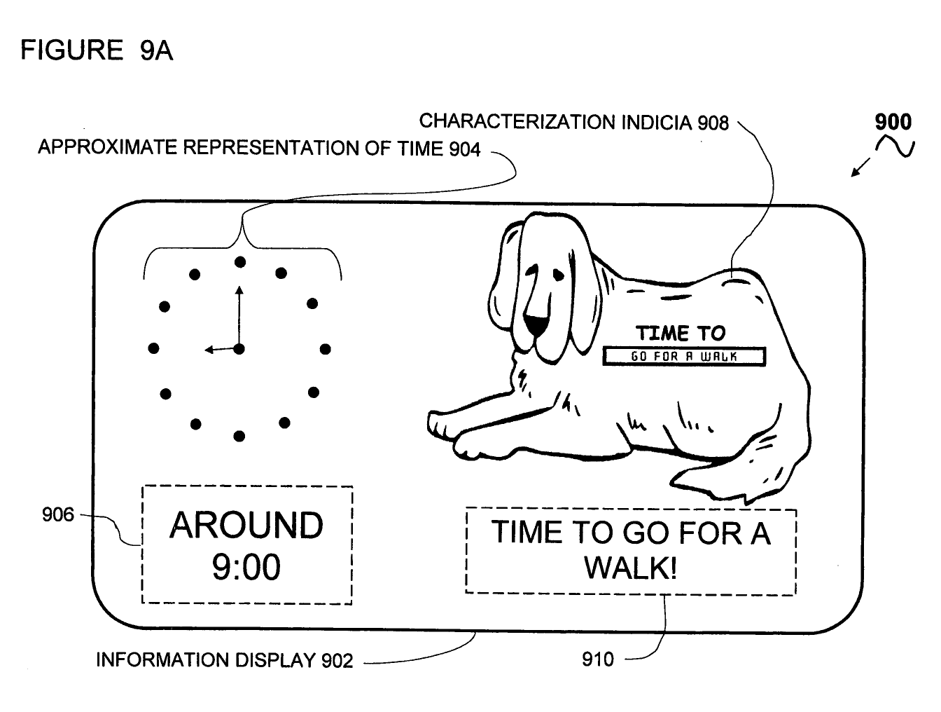

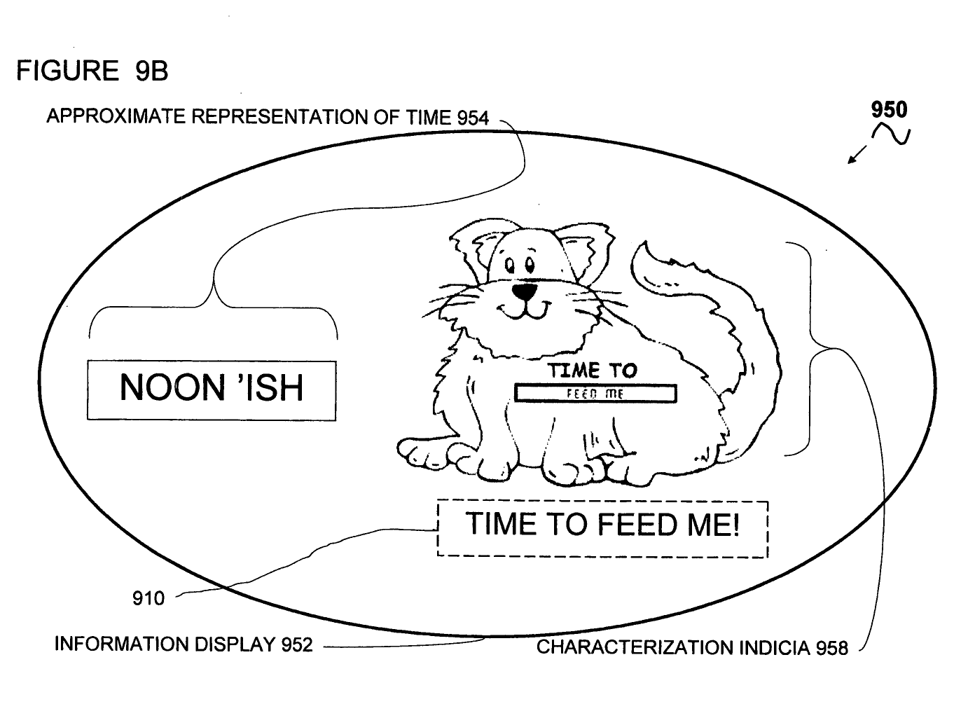

FIG. 9A illustrates communicating time characterized according to an animal's need for exercise, generally at 900, according to one embodiment of the invention. With reference to FIG. 9A, an information display 902 includes an approximate representation of time 904. The approximate representation of time 904 is displayed as an analog clock face with hands; however, other approximate representations of time can be employed. One example of an alternative approximate representation of time is shown at 906 by the expression “AROUND 9:00.” A characterization indicium 908 is displayed on the information display 902. The characterization indicium 908 is in the form of a graphical expression (graphical image) of a dog, thereby imparting to the time communicated by the information display 902, a theme that the time is related to a dog. Within the characterization indicium 908 (image of the dog) a message “TIME TO GO FOR A WALK” is displayed according to predetermined criteria that associates a message with a time interval. Alternatively, or in addition to displaying the message “TIME TO GO FOR A WALK,” a characterization indicium 910 can be used to display the messages relating to the needs of the dog as they arise with the passage of time. Thus, the information display 902 communicates characterized time according to the needs of a dog.

FIG. 9B illustrates communicating time characterized according to an animal's need to eat, generally at 950, according to one embodiment of the invention. With reference to FIG. 9B, an information display 952 includes an approximate representation of time 954. A characterization indicium 958 is displayed on the information display 952. The characterization indicium 958 is in the form of a graphical expression (graphical image) of a cat; thereby, imparting to the time communicated by the information display a feline theme. Within the characterization indicium 908 (image of the cat) a message “TIME TO FEED ME” is displayed according to predetermined criteria. Thus, the information display 902 communicates characterized time according to the needs of a cat.

Such visual connection between time and the needs of an animal such as a dog or cat can be useful to teach a person or a child to minister to the needs of his or her pet. An information display in the form of a clock, or a program running on a computer can provide a degree of entertainment and intrigue that is lacking with the ordinary needs attendant upon ministering to an animal. By creating an atmosphere of entertainment and intrigue around heretofore monotonous activities, a child could be more likely to develop the habits necessary to perform acts such as feeding, walking, petting, brushing, etc. thereby, fulfilling his or her obligation to the animal which helps provide for peace and tranquility in the home. Additionally, an embodiment of the invention can be labeled according to a particular pet's name; thereby, personalizing the characterized time to a particular pet.

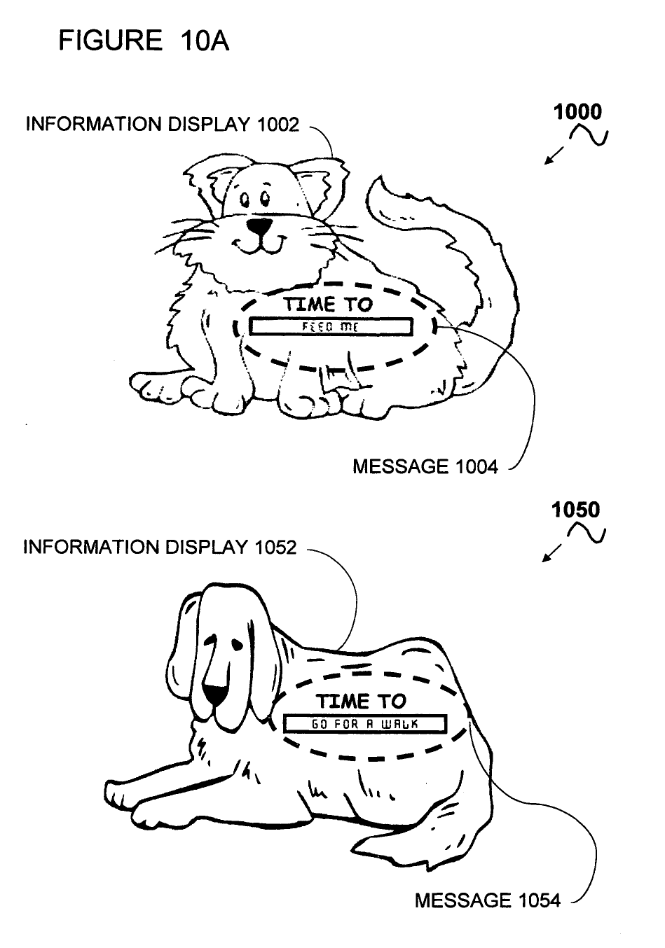

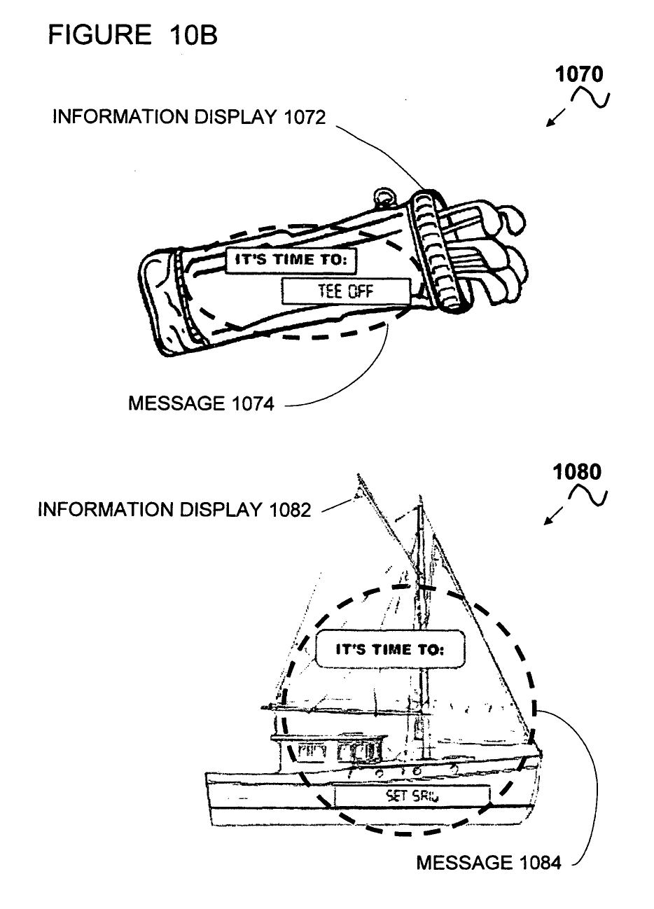

FIG. 10A illustrates characterizing time and activities related to the needs of animals, according to embodiments of the invention. With reference to FIG. 10A, an activity related to the needs of a cat is shown generally at 1000. An information display 1002, in a shape of a cat includes a message 1004. The message 1004 communicates to an observer of the information display 1002: “TIME TO FEED ME.” The message 1004 is one of a plurality of messages that can be displayed on the information display during intervals of time throughout the day and or night, according to embodiments of the invention.

Other messages that can be displayed on the information display 1002 are, but are not limited to, “TIME TO LET ME OUT,” “TIME TO LET ME IN,” “TIME TO ADORE ME, “TIME TO FEED ME AGAIN,” “TIME TO SLEEP,”“TIME TO SCRATCH,” “TIME TO PLAY WITH STRING,” “TIME TO WORRY THE DOG,” “TIME TO WAKE YOU UP.”

Referring again to FIG. 10A, an activity related to the needs of a dog is shown generally at 1050. An information display 1052, in a shape of a dog includes a message 1054. The message 1054 communicates to an observer of the information display 1052: “TIME TO GO FOR A WALK.” The message 1054 is one of a plurality of messages that can be displayed on the information display during intervals of time throughout the day and or night, according to embodiments of the invention.

Other messages that can be displayed on the information display 1052 are, but are not limited to, “TIME TO LET ME OUT,” “TIME TO LET ME IN,” “TIME TO FEED ME AGAIN,” “TIME TO SLEEP,” “TIME TO SCRATCH,”“TIME TO PLAY BALL,” “TIME TO CHASE THE CAT,” “TIME TO DIG UP ROSES,” “TIME TO CHEW ON MY BONE.”

FIG. 10B illustrates characterizing time by activities according to embodiments of the invention. With reference to FIG. 10B, characterizing time by an activity is represented, generally at 1070, by an image of a golf bag as represented by an information display 1072. A message 1074 communicates to an observer of the information display 1072 that it is time to “TEE OFF,” thereby characterizing time by an activity related to the sport of golf.

In various embodiments of the invention, a sequence of messages related to the sport represented by an information display is displayed sequentially in time. For example, referring to the information display 1072, in one embodiment, a series of messages related to different aspect of playing a game of golf might include: “TIME TO CHANGE TO A 9 IRON,” “TIME TO CHANGE TO A WOOD,” TIME TO GET OUT OF THE SAND TRAP,” “TIME TO LEAVE THE BALL IN THE LAKE,” “TIME FOR A HOLE IN ONE!,” “TIME TO HEAD BACK TO THE CLUB HOUSE,” “TIME FOR A BEER,” etc.

With reference to FIG. 10B, characterizing time by an activity is represented, generally at 1080, by an image of a sailboat as represented by an information display 1082. A message 1084 communicates to an observer of the information display 1082 that it is time to “SET SAIL,” thereby characterizing time by an activity related to sailing.

In various embodiments of the invention, a sequence of messages related to the activity represented by an information display is displayed sequentially in time. For example, referring to the information display 1082, in one embodiment, a series of messages related to different aspect of sailing might include: “TIME TO HOIST ANCHOR,” “TIME TO POINT UP,” TIME TO SHEET-IN,” “TIME TO RUN DOWN WIND,” “TIME TO REEF THE MAIN SAIL,” “TIME TO RIDE OUT THE STORM,” “TIME TO HOLD ON!,” “TIME TO GO BELOW,” “TIME TO ANCHOR,” etc.

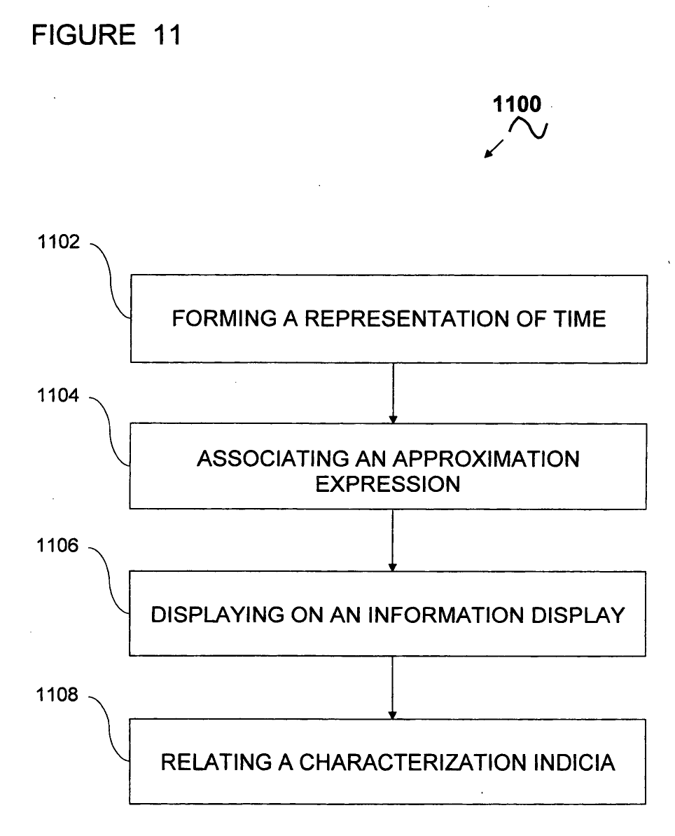

FIG. 11 illustrates a method of communicating characterized time, generally at 1100, according to embodiments of the invention. With reference to FIG. 11, an approximate representation of time is formed at a block 1102. Such a representation of time is formed using a combination of text based elements and or numerical elements and or graphical expressions. At a block 1104, an approximation expression is associated with the approximate representation of time from the block 1102. At a block 1106 a characterization indicium is related to the results of the processes resulting from blocks 1102 and 1104. At a block 1108, the characterized approximate representation of time is displayed on an information display.

A suitable information display includes, but is not limited to, a physical clock which includes a screen on which information can be displayed, such as a liquid crystal (LCD) display, a thin film transistor (TFT) display, a cathode ray tube (CRT) display, etc. Note that the information display can be made with a relatively coarse resolution having fewer display elements (pixels) or the information display can be made with increased resolution having a resolution sufficient to display graphical expressions in the form of images.

In some embodiments, a graphical expression in the form of an image is created by suitably coloring a surface such as with printing techniques apart from electronic methods of displaying information. In such embodiments, part of the information on the information display is static, not changing with time, while other parts of the information display are dynamic and therefore change at points in time as information is written to the display elements that form an electronic portion of the information display.

For example, referring back to FIG. 9A, the characterization indicium 908 can be a printed static portion of an information display 902, while the portion within the characterization indicium 908 that contains the phrase “GO FOR A WALK” is an electronic portion of the information display 902 that is capable of being changed over time. Alternatively, the entire characterization indicium 908 can be an image displayed on an electronic information display 902. In yet another embodiment, a single information display is used to display and to characterize time for a plurality of pets. A user can configure the information display for his or her group of pets together with each pet's needs within appropriate time intervals.

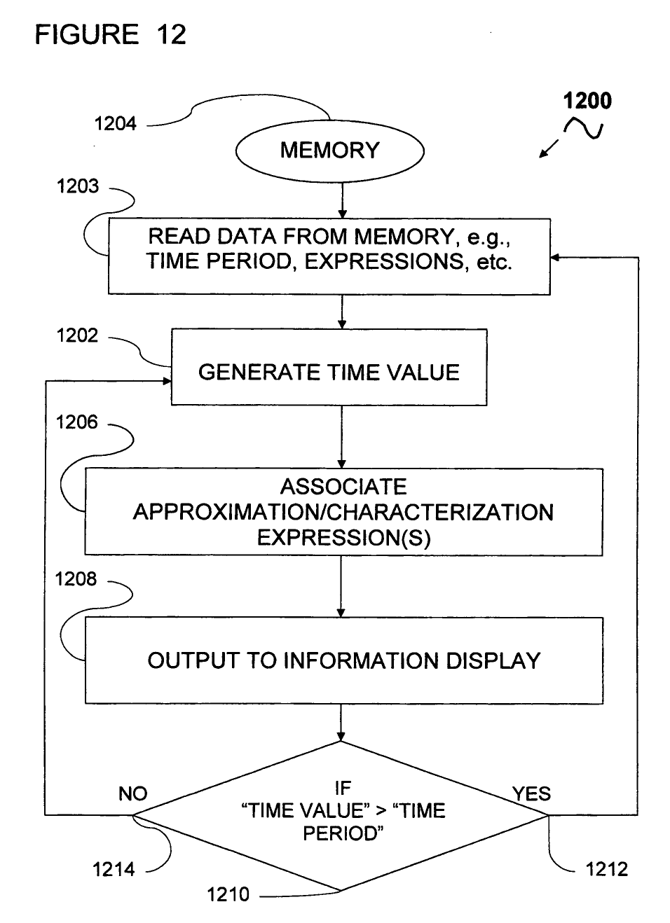

FIG. 12 depicts producing approximate characterized time, generally at 1200, according to various embodiments of the invention. FIG. 12 finds application within computer systems employing discrete components that are coupled via communication buses. Alternatively, FIG. 12 finds application within a single integrated circuit. Alternatively, FIG. 12 finds application within a circuit designed for computing time and retrieving values from storage (such as a lookup table). Alternatively, FIG. 12 finds application within in a software application running on a general purpose computer system (e.g., personal computer), a special purpose computer (e.g., personal digital assistant (PDA), smart phone, etc.), etc. Embodiments of the invention are not limited by the particular way in which the procedures embodied within FIG. 12 are implemented. Note also that architecture other than that shown in FIG. 12 can be implemented to accomplish the results of FIG. 12. It is contemplated that all such variations are within the scope of embodiments described herein.

With reference to FIG. 12, a time value is generated at a block 1202 by a suitable device, such as a time circuit (implemented in hardware) or a computer software program or by various methods that are known to those of skill in the art. If “data” has not been previously read from memory/storage, at a block 1204, then a time value is used to read, at a block 1203, appropriate data from memory (storage) 1204. “Data” includes a time-interval that is associated with the time value, data related to the elements (numerical elements, text elements, graphical expression, etc.) required to display an approximate representation of time, approximation expression, and a characterization indicium. Note that in some embodiments, not all of the aforementioned “data” is read from storage, some of the information can exist on the information display apart from an electronic method of display, as described above in conjunction with the preceding figures.

At a block 1206, elements of the “data,” that correspond with the time value, are associated to provide an association between the approximation expression and the characterization expression. In one embodiment, association is provided via display coordinates that define locations on the information display for the placement or display of the data elements. In other embodiments, association is accomplished with advanced placement of some of the data elements on an information display. In yet other embodiments, an association is accomplished with a combination of the aforementioned methods of associating.

At a block 1208 the “data” and the time value are output to the information display to provide an observer with a characterized approximate representation of time. An example is illustrated in FIG. 4A, where “1:00 ′ISH PORT TOWNSEND TIME” is displayed on the information display 402 as 404, 405, and 406. In this example, a time interval could be from fifty-two minutes thirty seconds past twelve o'clock (12:52:30) through seven minutes thirty seconds past one o'clock (1:07:30), resulting in the display shown in FIG. 4A during that time interval. Other time intervals are readily implemented and embodiments of the invention are not limited by the time interval or to the time interval given in this example.

At a block 1210, the time value is compared to the time interval. If the time value is less than an upper bound of the time interval then a new time value is generated by passing control via path 1212 back to the block 1202. If the time value is not less than the upper bound of the time interval (which means that the time has progressed beyond the time interval) then new data is read from storage by passing control via a path 1214 back to the block 1204. An example is illustrated in FIG. 4B, where an upper bound of the time interval could be in between a quarter past one o'clock (1:15) and a half past one o'clock (1:30), i.e., twenty-two minutes thirty seconds past one o'clock (1:22:30), resulting in the approximate representation of time 424 shown in FIG. 4B during the updated time interval. As stated above, other time intervals are readily implemented and embodiments of the invention are not limited by the time interval or to the time interval given in this example.

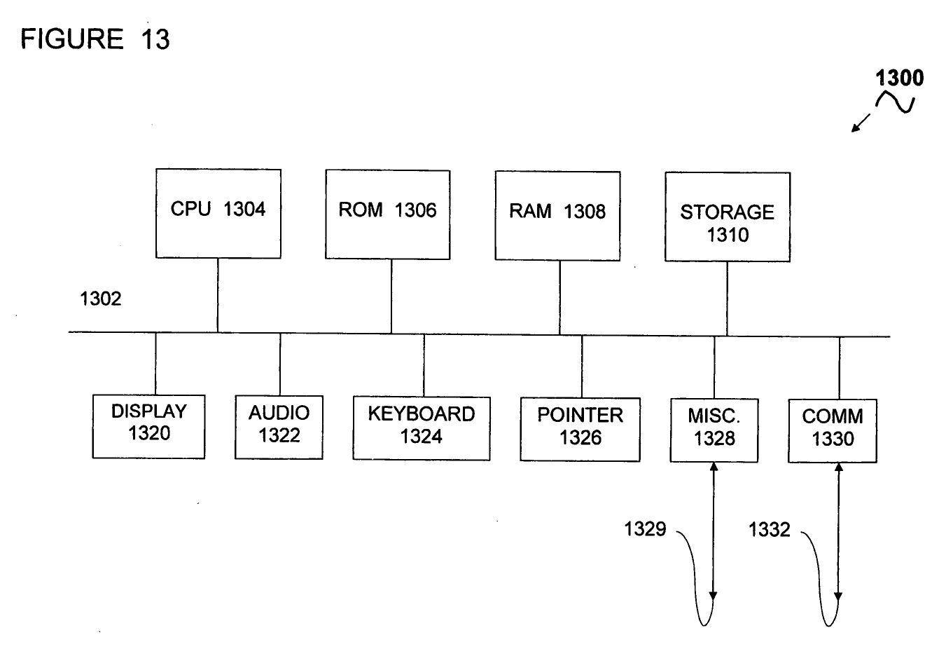

FIG. 13 illustrates, generally at 1300, a block diagram of a computer system (data processing device) in which embodiments of the invention may be used. The block diagram is a high-level conceptual representation and may be implemented in a variety of ways and by various architectures. Bus system 1302 interconnects a Central Processing Unit (CPU) 1304, Read Only Memory (ROM) 1306, Random Access Memory (RAM) 1308, storage 1310, display 1320, audio, 1322, keyboard 1324, pointer 1326, miscellaneous input/output (I/O) devices 1328, and communications 1330. The bus system 1302 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 1304 may be a single, multiple, or even a distributed computing resource. Storage 1310 may be Compact Disc (CD), Digital Versatile Disk (DVD), hard disks (HD), optical disks, tape, flash, memory sticks, video recorders, etc. Display 1320 might contain, for example, various embodiments of the present invention displayed thereon as characterized approximate representations of time. Note that depending upon the actual implementation of a computer system, the computer system may include some, all, more, or a rearrangement of components in the block diagram. Thus, many variations on the system of FIG. 13 are possible.

Thus, in various embodiments, characterized approximate time is communicated to an observer of an information display, such as on display 1320, as illustrated in FIG. 13. Connection with a network is obtained with 1332 via 1330, as is recognized by those of skill in the art, which enables the data processing device 1300 to communicate with other data processing devices in remote locations.

For example, embodiments of the invention can be implemented on a computer system 1300 configured as a desktop computer or work station, on for example a WINDOWS® compatible computer running operating systems such as WINDOWS® XP Home or WINDOWS® XP Professional, Linux, etc. as well as computers from APPLE COMPUTER, Inc. running operating systems such as OS X, etc. Alternatively, or in conjunction with such an implementation, an embodiment of the invention can be configured to operate as a wall clock. Depending on the implementation of a given embodiment, the wall clock and the desktop computer could be in wireless communication with each other thereby providing control of the wall clock from the desktop computer.

As mentioned above, embodiments of the invention can be configured to operate on smart phones such as a Palm® 650, a Palm® Treo™ 700 W running WINDOWS® MOBILE™ Version 5.0, etc.

In yet other embodiments, a single integrated circuit is employed to provide the required time measurement function, data table lookup, and display driver functions. In yet other embodiments, no integrated circuit will be employed; instead, one or more circuits provide an estimate of time, retrieve values from storage (memory) and output values to a data display (information display) thereby providing a characterized approximate representation of time to an observer.

In some embodiments of the invention, controls are provided for a user to configure the operation of an information display configured to provide characterized approximate representations of time. For example, a characterization theme can be selected by a user from, for example, the list of themes represented in FIG. 2, as well as from various activities such as, but not limited to, sleeping, eating, sailing, exercise, a user defined sport, etc. Graphical expressions are chosen from libraries of shapes, figures, images, etc. A characterization indicium can be selected from places and activities as previously described as well and a characterization indicium can be selected to customize a given embodiment for a theme of a cat, a dog, bird, a fish, a horse, multiple animals, etc. A user can select numerical and text elements for display and the user can set time intervals. Text elements are selectable, such as but not limited to, “′ISH,” “ISH,” “about,” “almost,” “nearly,” “and “after.” In certain embodiments, where memory and or space might be limited on an information display employing an embodiment of the invention on a wireless client, e.g., a wall clock implementation, a desktop computer can be used to allow the user to setup the wireless client utilizing the user interface controls available on the desktop computer.

Wireless communications facilitate communications between the wireless client and the desktop computer or a server accessed over the Internet. Awireless communication link 1329 and/or 1332 can be a communications link utilizing the IEEE 802.11a, IEEE 802.11b, IEEE 80211x, IEEE 802.15 (Bluetooth) standards (originating in the United States), as well as the HiperLAN standards (originating in Europe) or other wireless communications standards that permit wireless communications between devices.

For purposes of discussing and understanding embodiments of the invention described herein, it is to be understood that various terms are used by those knowledgeable in the art to describe techniques and approaches. Furthermore, in this description, for purposes of explanation, numerous specific details are set forth in order to provide a thorough understanding of the embodiments of the invention presented. It will be evident, however, to one of ordinary skill in the art that embodiments of the invention may be practiced without these specific details. In some instances, well-known structures and devices are shown in block diagram form, rather than in detail, in order to avoid obscuring embodiments of the invention. These embodiments are described in sufficient detail to enable those of ordinary skill in the art to practice the invention, and it is to be understood that other embodiments may be utilized and that logical, mechanical, electrical, and other changes may be made without departing from the scope of the embodiments of the invention described.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement embodiments of the invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, Digital Versatile Disk (DVD), compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to embodiments of the invention can be implemented in hard-wired circuitry, by programming a general-purpose processor, or by any combination of hardware and software. One of ordinary skill in the art will immediately appreciate that embodiments of the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. Embodiments of the invention can also be practiced in distributed computing environments where tasks are performed by remote processing devices that are linked through a communications network.

The methods described within embodiments of the invention may be implemented using computer software. If written in a programming language conforming to a recognized standard, sequences of instructions designed to implement the methods can be compiled for execution on a variety of hardware platforms and for interface to a variety of operating systems. In addition, the embodiments of the invention presented are not described with reference to any particular programming language. It will be appreciated that a variety of programming languages may be used to implement the teachings of the embodiments of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques described in embodiments of the invention may be practiced as well as implemented as an embodiment thereof).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases mean that the feature(s) being described is included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
an information display;
an approximate representation of time, the approximate representation of time is displayed on the information display and the approximate representation of time communicates an approximate time to an observer; and
a characterization indicium, the characterization indicium is displayed on the information display and the characterization indicium associates a theme with the approximate time to provide a characterized approximate time.

2. The apparatus of claim 1, wherein the characterization indicium is user selectable.

3. The apparatus of claim 1, wherein the approximate representation of time includes a numerical expression of time.

4. The apparatus of claim 1, wherein the approximate representation of time includes a first hand that corresponds to an hour and a second hand that corresponds to a minute.

5. The apparatus of claim 1, wherein the approximate representation of time includes a graphical expression of time.

6. The apparatus of claim 1, wherein the approximate representation of time includes a word selected from the group consisting of midnight and noon.

7. The apparatus of claim 1, wherein the characterization indicium associates a place with the approximate time.

8. The apparatus of claim 7, wherein the characterization indicium is selected from the group consisting of Port Townsend Time, Island Time, Country Time, Mountain Time, Wine Country Time, New York Time, Paris Time, and a geographical area.

9. The apparatus of claim 1, wherein the characterization indicium associates a theme with the approximate time.

10. The apparatus of claim 9, wherein the characterization indicium is selected from the group consisting of retired time, teen time, cruise ship time, resort time, my time, brother-in-law time, sister-in-law time, fishing, clamming, sailing, sun tanning, walking, running, a sport, eating, sleeping, vacation time, and entertainment.

11. The apparatus of claim 10, the characterization indicium is selected from the group consisting of a text message and a graphical image.

12. The apparatus of claim 1, wherein the characterization indicium associates an animal with the approximate time.

13. The apparatus of claim 12, wherein the animal is selected from the group consisting of a dog, a cat, a bird, a fish, and a horse.

14. The apparatus of claim 1, wherein a number of approximate times are communicated within a time period.

15. The apparatus of claim 14, wherein the number is four when the time period is one hour.

16. The apparatus of claim 1, wherein the approximate representation of time is displayed during a time interval.

17. The apparatus of claim 1, wherein the approximate representation of time includes a text message.

18. The apparatus of claim 17, wherein the text message is selected from the group consisting of around, ′ish, ish, about, almost, nearly, and after.

19. The apparatus of claim 1, wherein the approximate representation of time includes a graphical expression.

20. The apparatus of claim 19, wherein the graphical expression has a shape which is a full circle.

21. The apparatus of claim 19, wherein the graphical expression has a shape, which is less than a full circle.

22. The apparatus of claim 21, wherein less than the full circle corresponds to approximately 270 degrees of circumferential extent.

23. The apparatus of claim 19, wherein the graphical expression is associated with an activity.

24. The apparatus of claim 23, wherein the activity is selected from the group consisting of sleeping, eating, sailing, exercise, a sport, and entertainment.

25. The apparatus of claim 19, wherein the graphical expression is selected from the group consisting of a circle, an oval, a square, a cloud, and a quadrilateral.

26. An apparatus comprising:
a memory, the memory contains an approximation expression and a time period;
a time circuit, the time circuit is configured to generate an estimate of time;
an association circuit, the association circuit is coupled with the memory and the time circuit, the association circuit is configured to associate the approximation expression with the estimate of time during the period of time;
an information display, the information display is configured to display the approximation expression so that an approximate time is communicated to an observer during the time period; and
a characterization indicium, the characterization indicium is displayed on the apparatus and is visible to the observer, the characterization indicium associates a theme with the approximate time.

27. The apparatus of claim 26, wherein the approximation expression includes a text message.

28. The apparatus of claim 26, wherein the approximation expression includes a graphical expression.

29. The apparatus of claim 28, wherein the graphical expression is associated with an activity.

30. The apparatus of claim 26, wherein the characterization indicium associates a place with the approximate time.

31. The apparatus of claim 30, wherein the characterization indicium is selected from the group consisting of Port Townsend Time, Island Time, Country Time, Mountain Time, Wine Country Time, New York Time, Paris Time, and a geographical area.

32. The apparatus of claim 26, wherein the characterization indicium associates an activity with the approximate time.

33. The apparatus of claim 32, wherein the activity is selected from the group consisting of sleeping, eating, sailing, exercise, a sport, and entertainment.

34. A method comprising:
forming an approximate representation of time, the approximate representation of time includes an approximation expression;
displaying on an information display the approximate representation of time and the approximation expression for a period of time to communicate an approximate time to an observer during the period of time; and
relating a characterization indicium with the approximate time, the characterization indicium associates a theme with the approximate time.

35. The method of claim 34, wherein the approximate representation of time includes a numerical expression of time.

36. The method of claim 34, wherein the approximate representation of time includes a first hand that corresponds to an hour and a second hand that corresponds to a minute.

37. The method of claim 34, wherein the approximate representation of time includes a graphical expression of time.

38. The method of claim 34, wherein the approximation expression is a text message.

39. The method of claim 34, wherein the approximation expression is a graphical expression.

40. The method of claim 39, wherein the graphical expression is associated with an activity.

41. The method of claim 34, wherein the characterization indicium associates a place with the approximate time.

42. The method of claim 41, wherein the characterization indicium is selected from the group consisting of Port Townsend Time, Island Time, Country Time, Mountain Time, Wine Country Time, New York Time, Paris Time, and a geographical area.

43. The method of claim 34, wherein the characterization indicium associates a message with the approximate time.

44. A computer readable medium containing executable computer program instructions, which when executed by a data processing system, cause the data processing system to perform a method comprising:
forming an approximate representation of time, the approximate representation of time includes an approximation expression;
displaying on an information display the approximate representation of time and the approximation expression for a period of time to communicate an approximate time to an observer during the period of time; and
relating a characterization indicium with the approximate time, the characterization indicium associates a theme with the approximate time.

45. The computer readable medium, as set forth in claim 44, wherein the approximate representation of time includes a graphical expression of time.

46. The computer readable medium, as set forth in claim 44, wherein the characterization indicium associates a place with the approximate time.

47. The computer readable medium, as set forth in claim 44, wherein the characterization indicium associates a message with the approximate time.
